(19) United States
(12) Patent Application Publication
(10) Pub. No.: US 2017/0213572 A1
(43) Pub. Date: Jul. 27, 2017

(54) DETECTION OF READ-WRITE HEAD TOUCHDOWN USING HEAD ACTUATOR

(71) Applicant: HGST Netherlands B.V., Amsterdam (NL)

(72) Inventors: Erhard Schreck, San Jose, CA (US); Na Wang, San Jose, CA (US); Shaomin Xiong, San Jose, CA (US)

(21) Appl. No.: 15/164,030

(22) Filed: May 25, 2016

(51) Int. Cl. G11B 5/60; G11B 5/455; G11B 5/48

(52) U.S. Cl. CPC G11B 5/6058; G11B 5/483; G11B 5/455

(57) ABSTRACT

Described herein is a magnetic storage device that includes a magnetic disk and an arm rotatably movable relative to the magnetic disk. The magnetic storage device also includes a head actuator that is co-movable with the arm. The head actuator includes at least one piezo-electric element and at least one electronic communication signal line. Additionally, the magnetic storage device includes a read-write head coupled to the head actuator. The head actuator is operable to move the read-write head relative to the arm responsive to a first electronic signal received from the at least one electronic communication signal line. The magnetic storage device further includes a sensor module that is configured to determine whether the read-write head has touched down against the magnetic disk based on, at least partially, a second electronic signal received from the head actuator via the at least one electronic communication signal line.

### FIELD

This disclosure relates generally to magnetic storage devices, and more particularly to detecting the touchdown of a read-write head against a disk of a magnetic storage device using the return signal of a head actuator.

### BACKGROUND

Magnetic storage devices, such as hard disk drives (“HDDs”), are widely used to store digital data or electronic information for enterprise data processing systems, computer workstations, portable computing devices, digital audio players, digital video players, and the like. Generally, HDDs store data on a disk with a layer of magnetic material. A read-write head, positioned at the end of an arm, includes a writing component that magnetically polarizes areas or bits of the magnetic material with one or two polarities to encode either binary zeros or ones. Thus, data is recorded as magnetically encoded areas or bits of magnetic polarity. The direction of the magnetization points in different directions, which can be referred to as a positive state and a negative state. Each bit can store information (generally binary information in the form of either a 1 or a 0) according to the magnetic polarization state of the bit. Typically, bits are arranged along respective radially-adjacent (e.g., concentric) annular tracks of a disk. A single disk can include space for millions of tracks each with millions of bits. A transducer head also includes a reading component that detects the magnetic polarity of each bit or area and generates an electrical signal that approximates the magnetic polarity. The signal is processed to recover the binary data recorded on the magnetic material.

The disks of an HDD rotate as read-write heads hover over the respective disks to read data from and write data to the disks. The position of the arm, and thus the position of the read-write heads, relative to the disks is controlled via actuation of a voice coil magnetic (VCM) actuator. As the disks rotate, the VCM actuator rotates the arm to move the read-write heads radially inwardly or outwardly over the disks. Due to the continually increasing areal density and tracks per inch (TPI) of conventional magnetic recording disks, precisely positioning the read-write heads over the disks with just a VCM actuator can be difficult. Accordingly, some conventional HDDs employ a head actuator or a load beam actuator to more precisely position the read-write head over the disks.

Determining whether read-write heads are touching down against a disk during operation of an HDD can be important for maintaining the performance of the HDD. Conventional methods for detecting head touchdown events are prone to inaccuracies and require placement of electrical contact sensors in particular locations relative to the read-write head, which introduces spacing and design constraint limitations.

### SUMMARY

A need exists for an apparatus, system, and method for detecting a touchdown of a read-write head that overcomes the shortcomings of conventional HDDs. The subject matter of the present application has been developed in response to the present state of HDD art, and in particular, in response to problems and needs in the art, such as those discussed above, that have not yet been fully solved by currently available HDDs. Accordingly, the embodiments of the present disclosure overcome at least some of the shortcomings of the prior art.

According to a first embodiment of a magnetic storage device, which is fully operational to store digital data, the magnetic storage device includes a magnetic disk and an arm rotatably movable relative to the magnetic disk. The magnetic storage device also includes a head actuator that is co-movable with the arm. The head actuator includes at least one piezo-electric element and at least one electronic communication signal line. Additionally, the magnetic storage device includes a read-write head coupled to the head actuator. The head actuator is operable to move the read-write head relative to the arm responsive to a first electronic signal received from the at least one electronic communication signal line. The magnetic storage device further includes a sensor module that is configured to determine whether the read-write head has touched down against the magnetic disk based on, at least partially, a second electronic signal received from the head actuator via the at least one electronic communication signal line.

In some implementations of the first embodiment of the magnetic storage device, the head actuator is operable to adjust a flying height of the read-write head relative to the magnetic disk.

According to certain implementations of the first embodiment of the magnetic storage device, the head actuator is operable to move the read-write head relative to the arm in at least four directions parallel to the magnetic disk.

According to at least one implementation of the first embodiment of the magnetic storage device, the read-write head is coupled directly to the head actuator.

In certain implementations of the first embodiment of the magnetic storage device, the sensor module determines that the read-write head has touched down against the magnetic disk when a voltage characteristic of the second electronic signal meets a voltage characteristic threshold. The voltage characteristic can include a period of sustained magnitude.

In some implementations, the first embodiment of the magnetic storage device further includes a housing entirely enclosing the magnetic disk, the arm, the head actuator, and the read-write head.

According to some implementations, the first embodiment of the magnetic storage device additionally includes a load beam coupled to a first distal end of the arm. The head actuator and the read-write head are positioned at a second distal end of the load beam.

In yet some implementations of the first embodiment of the magnetic storage device further, in a direction perpendicular to a read-write surface of the magnetic disk, the read-write head is interposed directly between the head actuator and the read-write surface of the magnetic disk.

According to a second embodiment of a magnetic storage device, the magnetic storage device includes a magnetic disk, an arm rotatably movable relative to the magnetic disk, and a load beam coupled to a first distal end of the arm and rotatably movable relative to the arm. The magnetic storage device also includes a load beam actuator that includes at least one first piezo-electric element and is operable to rotate the load beam relative to the arm. Additionally, the magnetic storage device includes a head actuator co-movable with the load beam. The head actuator includes at least one second piezo-electric element. The magnetic storage device further includes a read-write head coupled to the head actuator. The head actuator is operable to move the read-write head relative to the load beam. The magnetic storage device also includes a sensor module that is configured to determine whether the read-write head has touched down against the magnetic disk based on, at least partially, a first electronic signal received from the head actuator.

In some implementations of the second embodiment of the magnetic storage device, the sensor module is configured to determine whether the read-write head has touched down against the magnetic disk based further on, at least partially, a second electronic signal received from the load beam actuator. The sensor module can be further configured to determine whether the read-write head has touched down against the magnetic disk based on, at least partially, a comparison between the first electronic signal and the second electronic signal. The comparison may include a difference between a voltage of the first electronic signal and a voltage of the second electronic signal.

According to certain implementations of the second embodiment of the magnetic storage device, the head actuator and the read-write head are coupled to the load beam at a second distal end of the load beam.

In one embodiment, a method of detecting a touchdown of a read-write head on a magnetic disk of a magnetic storage device during operation of the magnetic storage device is disclosed. The magnetic storage device includes an arm that is rotatable relative to the magnetic disk. The method includes monitoring a return signal from a head actuator of the magnetic storage device, where the head actuator includes at least one piezo-electric element and is operable to move the read-write head relative to the arm. Additionally, the method includes comparing a voltage characteristic of the return signal from the head actuator to a first threshold. The method also includes detecting the touchdown of the read-write head on the magnetic disk when the voltage characteristic of the return signal from the head actuator meets the first threshold. Furthermore, the method includes adjusting a position of the read-write head relative to the magnetic disk in response to detecting the touchdown of the read-write head on the magnetic disk.

According to some implementations of the method, the magnetic storage device further includes a load beam coupled to a first distal end of the arm. The head actuator is operable to move the read-write head relative to the load beam. Furthermore, the head actuator and the read-write head are positioned at a second distal end of the load beam. The method may additionally include monitoring a return signal from a load beam actuator of the magnetic storage device. The load beam actuator can include at least one piezo-electric element and be operable to move the load beam relative to the arm. Also, the method can include comparing a voltage characteristic of the return signal from the load beam actuator to a second threshold. Furthermore, the method may include detecting the touchdown of the read-write head on the magnetic disk when the voltage characteristic of the return signal from the head actuator meets the first threshold and the voltage characteristic of the return signal from the load beam actuator meets the second threshold.

In certain implementations of the method, the head actuator adjusts the position of the read-write head relative to the magnetic disk in response to detecting the touchdown of the read-write head on the magnetic disk. The head actuator can adjust a flying height of the read-write head relative to the magnetic disk in response to detecting the touchdown of the read-write head on the magnetic disk.

According to yet some implementations, the method further includes sealing the read-write head, magnetic disk, arm, and head actuator within an enclosure prior to monitoring the return signal from the head actuator of the magnetic storage device.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1 is a perspective view of a magnetic storage device, according to one or more embodiments of the present disclosure;

FIG. 2 is a perspective view of arms, load beams, and read-write heads of a magnetic storage device, according to one or more embodiments of the present disclosure;

FIG. 3 is a top plan view of an arm, a load beam, and a read-write head relative to a disk of a magnetic storage device, according to one or more embodiments of the present disclosure;

FIG. 4 is a side elevation view of an arm, a load beam, and a read-write head relative to a disk of a magnetic storage device, shown with the read-write head at a flying height away from the disk, according to one or more embodiments of the present disclosure;

FIG. 5 is a side elevation view of the arm, load beam, and read-write head of FIG. 4, shown with the read-write head touching down against the disk, according to one or more embodiments of the present disclosure;

FIG. 6 is a schematic box diagram of a system for detecting a touchdown of a read-write head on a magnetic disk of a magnetic storage device, according to one or more embodiments of the present disclosure;

FIG. 7 is a schematic flow chart of a method of detecting a touchdown of a read-write head on a magnetic disk of a magnetic storage device during operation of the magnetic storage device, according to one or more embodiments of the present disclosure; and

FIG. 8 is a schematic flow chart of a method of detecting a touchdown of a read-write head on a magnetic disk of a magnetic storage device during operation of the magnetic storage device, according to one or more embodiments of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

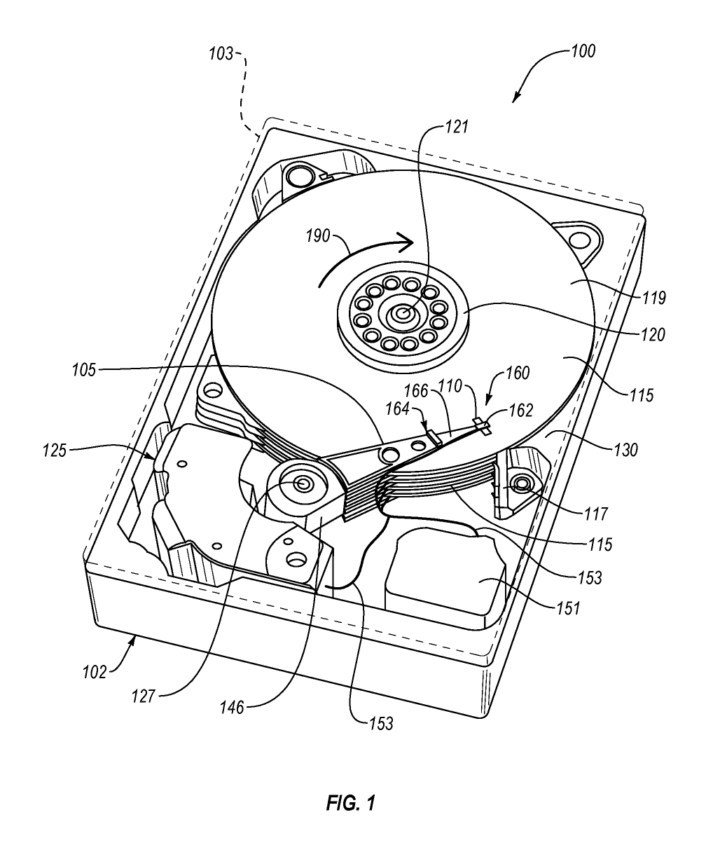

Referring to FIG. 1, a magnetic storage device 100, according to one embodiment, is depicted as a hard disk drive (HDD). However, in other embodiments, the magnetic storage device 100 can be another type of magnetic storage device. The HDD 100 includes an enclosure 102 that encloses (e.g., hermetically sealingly encloses in some implementations) arms 105, read-write heads 110, disks 115, a spindle motor 120, and a voice coil magnetic (VCM) actuator 125. The enclosure 102 includes a cover 103 (shown in hidden lines in FIG. 1 so as not to obscure internal features of the HDD 100 within the enclosure 102) coupled (e.g., hermetically sealingly coupled in some implementations) to a base 130. The base 130 defines a cavity within which internal features of the HDD 100 are positioned. Although the HDD 100 is shown having five arms 105, one read-write head 110 per arm, four disks 115, one spindle motor 120, and one VCM actuator 125, any number of arms 105, read-write heads 110, disks 115, spindle motors 120, and VCM actuators 125 may be employed.

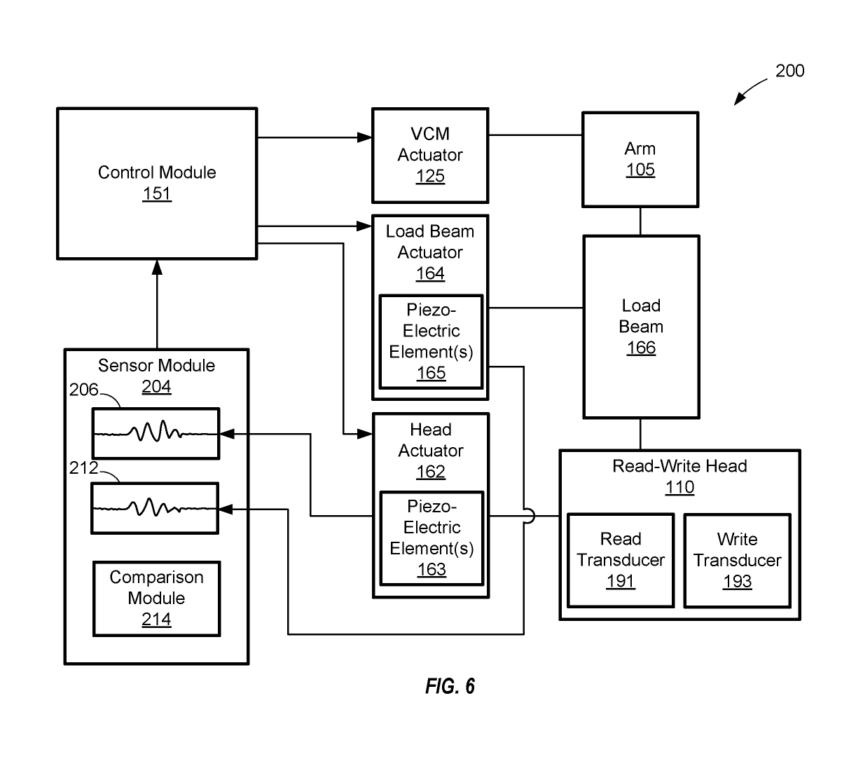

The spindle motor 120 is coupled to the base 130. Generally, the spindle motor 120 includes a stationary portion non-movably fixed relative to the base and a spindle that is rotatable relative to the stationary portion and the base 130. Accordingly, the spindle 120 can be considered to be part of or integral with the spindle motor. Generally, the spindle motor 120 is operable to rotate the spindle relative to the base. The disks 115, or platters, are co-rotatably fixed to the spindle of the spindle motor 120 via respective hubs 121, which are co-rotatably secured to respective disks and the spindle. As the spindle of the spindle motor 120 rotates, the disks 115 correspondingly rotate. In this manner, the spindle of the spindle motor 120 defines a rotational axis of each disk 115. The spindle motor 120 can be operatively controlled by a control module 151 (see, e.g., FIG. 6) to rotate the disks 115 a controlled amount at a controlled rate.

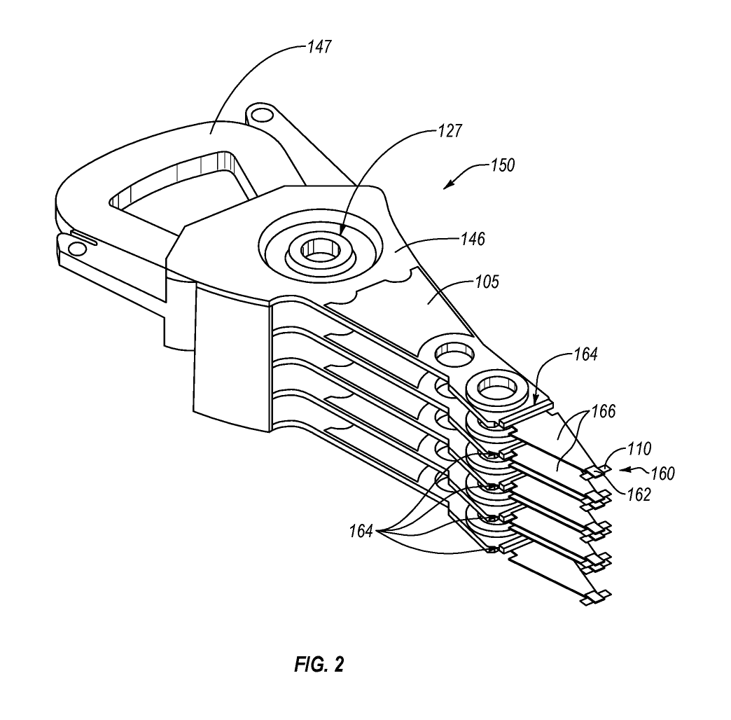

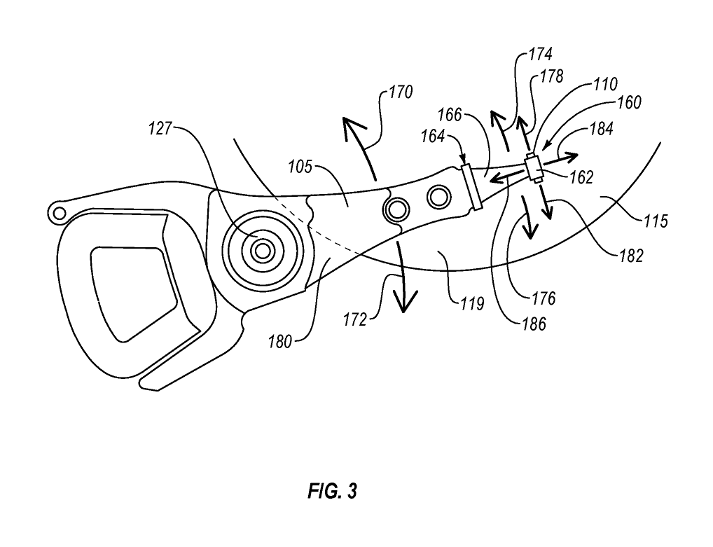

As the disks 115 rotate in a read-write mode, the VCM actuator 125 electromagnetically engages voice coils 147 (see, e.g., FIG. 2) of respective arms 105 to rotate the arms 105, and the read-write heads 110, which are coupled to the arms 105 as will be explained in more detail below, relative to the disks 115 in the rotational directions 170, 172 along a plane parallel to the read-write surfaces 119 of the disks 115 (see, e.g., FIG. 3). The arms 105 can be rotated to position the read-write heads 110 over a specified radial area of the read-write surfaces 119 of the disks 115 for read and/or write operations. The VCM actuator 125 is fixed to the base 130 in engagement with the voice coils 147 of the arms 105, which are rotatably coupled to the base 130 via a spindle 127 extending through the actuator body 146. Generally, the spindle 127 defines a rotational axis about which the arms 105 rotate when actuated by the VCM actuator 125.

The arms 105 are non-movably fixed to and extend away from the actuator body 146 in a spaced-apart manner relative to each other. In some implementations, the arms 105 are spaced an equi-distance apart from each other and extend parallel relative to each other. A respective one of the disks 115 is positioned between adjacent arms 105. In an idle mode (e.g., when read-write operations are not being performed), the VCM actuator 125 is actuated to rotate the arm 105, in a radially outward direction relative to the disks 115, such that each head 110 is parked or unloaded onto a ramp support 117 secured to the base 130.

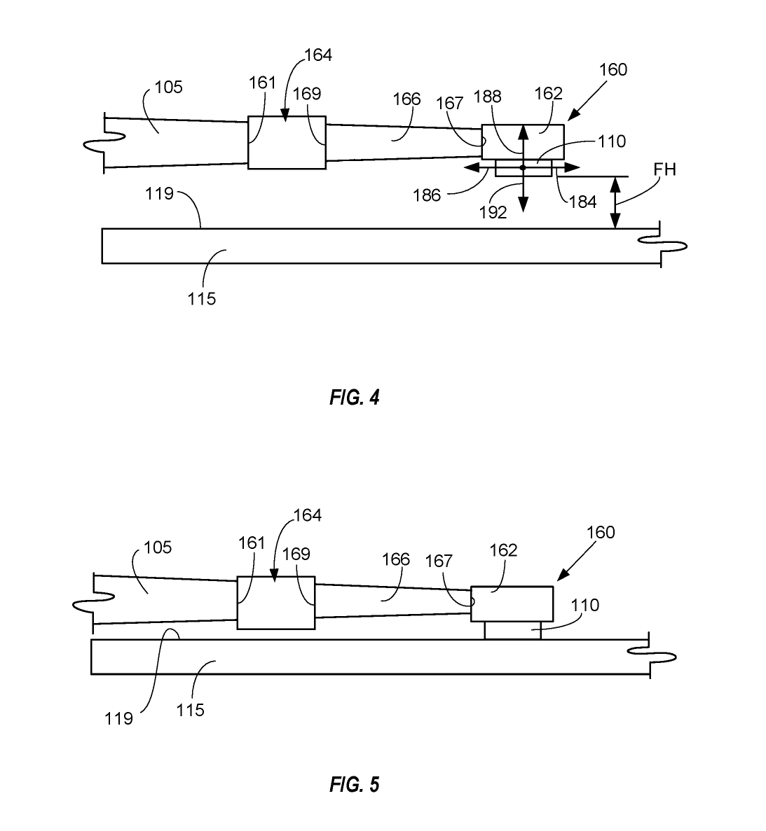

Referring to FIGS. 4-6, each read-write head 110 forms part of a head assembly 160 coupled with a distal end 161 of a respective arm 105 (see, e.g., FIGS. 4 and 5). The read-write head 110 includes at least one read transducer 191 and at least one write transducer 193. The read transducer 191 is configured to detect magnetic properties (e.g., magnetic bit patterns) of a disk 115 and convert the magnetic properties into an electrical signal. In contrast, the write transducer 193 changes the magnetic properties of a disk 115 responsive to an electrical signal. An arm 105 is suspended or spaced-apart relative to a read-write surface 119 of a disk 115 such that the read-write head 110 coupled with the arm 105 also is suspended or spaced-apart relative to the read-write surface 119 of the disk 115. The offset between the read-write head 110 and the read-write surface 119 of the disk 115 defines a flying height FH of the read-write head 110. Generally, the flying height FH of the read-write head 110 is controlled to provide a gap between the read-write head 110 and the read-write surface 119 that promotes a desired performance of the read-write operations of the read-write head 110 and ensures damage-inducing contact with the read-write surface 119 is avoided. As mentioned above, and with reference to FIG. 5, a touchdown event occurs when the flying height FH of the read-write head 110 is zero and the read-write head 110, directly or indirectly, contacts the read-write surface 119 of the disk 115.

The head assembly 160 also includes a head actuator 162 selectively operable to move the read-write head 110 relative to the arm 105. The head actuator 162 selectively moves the read-write head 110 in any of various manners and in any of various directions. For example, the head actuator 162 can be configured to move the read-write head 110 linearly in any of various directions, such as in one or more of a first sideways direction 178, a second sideways direction 182, a forward direction 184, and a backward direction 186, along a plane parallel to the read-write surface 119 of the disk 115 (see, e.g., FIG. 3). As another example, the head actuator 162 may be, alternatively or additionally, configured to move the read-write head 110 linearly in any of various directions, such as an upward direction 188 and a downward direction 192, along a plane perpendicular to the read-write surface 119 of the disk 115 (see, e.g., FIG. 4). Further, in some implementations, the head actuator 162 may be, alternatively or additionally, configured to move the read-write head 110 rotationally in any of various rotational directions along planes parallel to and/or perpendicular to the read-write surface 119 of the disk 115.

The head actuator 162 can be any of various actuators known in the art, such as, for example, so-called electrically-controlled micro-actuators and milli-actuators. As shown in FIG. 6, in one specific embodiment, the head actuator 162 is a piezo-electric actuator that includes at least one piezo-electric element 163. The head actuator 162 utilizes the properties of the piezo-electric element 163 to precisely and responsively control movement of the read-write head 110 relative to the arm 105.

The piezo-electric element 163 is made from any of various piezo-electric materials. As defined herein, a piezo-electric material is any solid material that accumulates an electric charge when deformed, vibrated, contacted, or otherwise agitated and deforms when subject to an electric charge. In other words, not only is a piezo-electric material capable of accumulating an electric charge when subject to a force or load, but also is capable of changing dimensions to generate a force or load when an electric field is applied to the material. In this manner, the piezo-electric element 163 can be considered or defined as a transducer. Accordingly, depending on the configuration or operating mode, the piezo-electric element 163 can act as an electric accumulator of electrical charge in response to the receipt of a physical load or actuate in response to the receipt of an electrical load. Generally, the deformation or actuation of the piezo-electric element 163 is directly proportional to the electrical charge applied to the piezo-electric element 163. Accordingly, the piezo-electric element 163 is able to deform or actuate with controlled characteristics. The inverse is also true, which is that because the electrical charge accumulated by the piezo-electric element 163 is proportional to the physical loads experienced by the piezo-electric element 163, the piezo-electric element 163 is able to accurately detect characteristics (e.g., magnitude (e.g., amplitude), frequency, etc.) of the physical loads experienced by the piezo-electric element 163. In other words, the piezo-electric element 163 can be both an actuator and a sensor.

According to one embodiment, the head actuator 162 includes multiple piezo-electric elements 163. In some implementations, one or more piezo-electric elements 163 can be actuated (e.g., retracted or expanded) to move the read-write head 110 in a first manner and first direction, and one or more other piezo-electric elements 163 can be actuated to move the read-write head 110 in a second manner and second direction. Generally, the head actuator 162 can include multiple piezo-electric elements 163 that are cooperatively controllable to move the read-write head 110 in any of various manners and directions as desired.

Although not shown, in some embodiments, the head assembly 160 is coupled directly to the distal end 161 of the arm 105. However, in the illustrated embodiments, the head assembly 160 is coupled indirectly to the distal end 161 of the arm 105 via a load beam 166, which is coupled to the distal end 161 of the arm 105. Accordingly, in such embodiments, movement of the read-write head 110 by the head actuator 162 is relative not only to the arm 105, but also to the load beam 166.

The load beam 166 is softer and more flexible than the arm 105 to resiliently support the head assembly 160 relative to the arm 105. For example, in some implementations, the load beam 166 is flexible to flex away from the read-write surface 119 of the disk 115 to allow the head assembly 160 move away from the read-write surface 119 of the disk 115, such as when an air bearing is formed between the read-write surface 119 and the head assembly 160 as the disk 115 spins relative to the head assembly 160. The load beam 116 can have a generally thin, sheet-like, construction and taper from the distal end 161 of the arm 105, when coupled to the arm 105, to a distal end 167 of the load beam 166. The head assembly 160 is coupled to the distal end 167 of the load beam 166 such that the load beam 166 is positioned between or separates the head assembly 160 from the distal end 161 of the arm 105. In this manner, the head assembly 160 is distally spaced apart from the distal end 161 of the arm 105 via the load beam 166. The load beam 166 is either directly or indirectly coupled to the distal end 161 of the arm 105.

According to some embodiments, the load beam 166 is directly coupled to the distal end 161 of the arm 105. In such embodiments, the load beam 166 is non-movably fixed to the distal end 161 of the arm 105. In other words, although the load beam 166 may flex to move portions of the load beam 166 relative to the arm 105, the portion of the load beam 166 immediately affixed to the arm 105 does not move relative to the arm 105. The load beam 166 can be non-movably fixed to the arm 105 via any of various coupling techniques, such as fastening, bonding, adhering, welding, and the like.

In contrast, in certain embodiments, the load beam 166 is indirectly coupled to the distal end 161 of the arm 105. In such embodiments, the load beam 166 can be non-movably fixed to the distal end 161 of the arm 105 or movably fixed to the distal end 161 of the arm 105. According to some implementations, the load beam 166 is movably fixed to the distal end 161 of the arm 105 via a load beam actuator 164. The load beam actuator 164 movably couples a proximal end 169 of the load beam 166, and thus the entire load beam 166, to the distal end 161 of the arm 105. A first portion of the load beam actuator 164 is fixed to the distal end 161 of the arm 105 and a second portion, movable relative to the first portion, is fixed to the proximal end 169 of the load beam 166. The load beam actuator 164 is configured to selectively move the load beam 166 relative to the arm 105. More specifically, as an example, the load beam actuator 164 selectively rotates the load beam 166, and thus the head assembly 160 relative to the arm 105, in the rotational directions 174, 176 along a plane parallel to the read-write surface 119 of the disk 115 (see, e.g., FIG. 3). The load beam actuator 164 can be any of various actuators known in the art, such as, for example, so-called electrically-controlled micro-actuators and milli-actuators. As shown in FIG. 6, in one specific embodiment, the load beam actuator 164 is a piezo-electric actuator that includes at least one piezo-electric element 165. The load beam actuator 164 utilizes the properties of the piezo-electric element 165 to precisely and responsively control the rotation of the load beam 166 relative to the arm 105.

Like the piezo-electric element 163 of the head actuator 162, the piezo-electric element 165 of the load beam actuator 164 is made from any of various piezo-electric materials, can be considered or defined as a transducer, and, depending on the configuration or operating mode, can act as an electric accumulator of electrical charge in response to the receipt of a physical load or actuate in response to the receipt of an electrical load. The deformation or actuation of the piezo-electric element 165 is directly proportional to the power of the electrical charge applied to the piezo-electric element 165. Accordingly, like the piezo-electric element 163, the piezo-electric element 165 is able to deform or actuate with controlled characteristics. Furthermore, the piezo-electric element 165 is able to accurately detect characteristics (e.g., magnitude (e.g., amplitude), frequency, etc.) of the physical loads experienced by the piezo-electric element 165. In other words, similar to the piezo-electric element 163, the piezo-electric element 165 can be both an actuator and a sensor.

According to one embodiment, the load beam actuator 164 includes two piezo-electric elements 165. In response to an electrical load applied to each of the piezo-electric elements 165, one piezo-electric element 165 is configured to deform in a first manner (e.g., retract), and the other piezo-electric element 165 is configured to deform in a second manner (e.g., expand). The contrasting retraction and expansion of the piezo-electric elements 165 of the load beam actuator 164 results in a rotation of the load beam 166 relative to the arm 105.

Referring to FIG. 1, the HDD 100 also includes a control module 151 mounted to the base 130. In this manner, the control module 151 is on-board or contained within the HDD 100, as opposed to forming part of an electrical device external to or separate from the HDD 100. Generally, the control module 151 includes software, firmware, and/or hardware used to control operation of the various components of the HDD 100. The control module 151 may include a printed circuit board on or in which the hardware is mounted. The control module 151 is electrically coupled to the VCM actuator 125, the read-write head 110, the head actuator 162, and the load beam actuator 164 via one or more electrical communication signal lines 153. The electrical communication signal lines 153 facilitate the transmission of power, commands, and data between the control module 151 and the VCM actuator 125, the read-write head 110, the head actuator 162, and the load beam actuator 164.

According to FIG. 6, one embodiment of a system 200 for detecting a touchdown of the read-write head 110 on the magnetic disk 115 of the HDD 100, during operation of the HDD 100, is shown. The system 200 includes the control module 151, which is configured to control operation of the VCM actuator 125 (to move the arm 105 coupled to the VCM actuator 125), the head actuator 162 (to move the read-write head 110 coupled to the head actuator 162), and the load beam actuator 164 (to move the load beam 166 coupled to the load beam actuator 164 and move the read-write head coupled to the load beam 166). Additionally, the system 200 includes a sensor module 204 configured to determine whether the read-write head 110 is touching down on the magnetic disk 115 of the HDD 100 based, at least partially, on a return signal from the head actuator 162. The sensor module 204, although shown separate from the control module 151, forms part of the control module 151 in some implementations. Accordingly, in some implementations, the sensor module 204 is entirely enclosed within the enclosure 102 of the HDD 100, and in other implementations, some or all of the sensor module 204 is external to the HDD 100.

While the HDD 100 is operating, the sensor module 204 receives a return signal 206 from the head actuator 162 via an electrical communication signal line 153. The return signal 206 corresponds with or indicates the voltage of the electric charge accumulated in the piezo-electric element 163 of the head actuator 162.

When the read-write head 110 is at a proper flying height FH away from the read-write surface 119 of the disk 115, agitation (e.g., vibration) of head actuator 162 is nominal, and thus little to no electric charge accumulates in the piezo-electric element 163. Accordingly, when the read-write head 110 is at a proper flying height FH, a magnitude of the voltage of the return signal 206 is nominal and less than a predetermined voltage magnitude threshold corresponding with the occurrence of a touchdown event. Under such circumstances, the sensor module 204 determines that the read-write head 110 is not touching down on the disk 115.

In contrast, when the read-write head 110 is actually touching down on the read-write surface 119 of the disk 115, agitation (e.g., vibration) of the head actuator 162 is significant due to the contact with the disk 115, and thus a significant alternating electric charge accumulates in the piezo-electric element 163. Accordingly, when the read-write head 110 is touching down on the disk 115, a magnitude of the voltage of the return signal 206 is relatively high and more than the predetermined voltage magnitude threshold. Under such circumstances, the sensor module 204 determines that the read-write head 110 is touching down on the disk 115. In some implementations, the magnitude of the voltage of the return signal 206 must meet or exceed the predetermined voltage magnitude threshold for a predetermined time period before the sensor module 204 will determine that the read-write head 110 is touching down on the disk 115.

Generally, in some implementations, the vibration during contact will cause the return signals of the present disclosure to be an alternating voltage signal. The sensor module 204 may then process the return signals (after rectification of the signals) using any of various techniques, such as with a peak detector to detect the peak voltage magnitude of the return signals or with a root-mean-square (RMS) detector to detect the RMS voltage magnitude of the return signals. Accordingly, depending on the type of processing of the return signals, the predetermined voltage magnitude threshold can be any of various predetermined voltage magnitude characteristic thresholds, such as a predetermined peak voltage magnitude threshold or a predetermined RMS voltage magnitude threshold.

According to other implementations, the sensor module 204 may process the return signals according to a bandwidth-limited detection scheme to determine frequency characteristics of the return signals. Accordingly, instead of comparing voltage magnitude characteristics of the return signals to corresponding voltage magnitude thresholds to determine if a touchdown event is occurring, in some implementations, the sensor module 204 compares frequency characteristics of the return signals to corresponding frequency thresholds to determine if a touchdown event is occurring. The frequency thresholds correspond with known frequencies that are excited during touchdown events.

For some implementations, where the head actuator 162 includes multiple piezo-electric elements 163, the sensor module 204 may receive a separate return signal 206 from each of the multiple piezo-electric elements 163. In one implementation, the sensor module 204 determines that the read-write head 110 is touching down on the disk 115 when the magnitude of the voltage of any one of the return signals 206 meets or exceeds the predetermined voltage magnitude threshold. However, in another implementation, the sensor module 204 determines that the read-write head 110 is touching down on the disk 115 when the magnitude of the voltage of at least two or all of the return signals 206 meets or exceeds the predetermined voltage magnitude threshold.

According to some embodiments, the sensor module 204 is configured to determine whether the read-write head 110 is touching down on the magnetic disk 115 of the HDD 100 based, at least partially, on the return signal 206 from the head actuator 162 and a return signal 212 from the load beam actuator 164. While the HDD 100 is operating, the sensor module 204 receives the return signal 212 from the load beam actuator 164 via an electrical communication signal line 153. The return signal 212 corresponds with or indicates the voltage of the electric charge accumulated in the piezo-electric element 165 of the load beam actuator 164. As with the return signal 206 from the head actuator 162, the sensor module 204 can be configured to determine whether the read-write head 110 is touching down on the disk 115 based, at least partially, on whether a magnitude of the voltage of the return signal 212 meets or exceeds a predetermined voltage magnitude threshold. However, because the load beam actuator 164 is positioned further away from the read-write head 110 than the head actuator 162, the piezo-electric element 165 of the load beam actuator 164 may be less sensitive to vibrations of the read-write head 110 caused by contact with the disk 115 than the piezo-electric element 163 of the head actuator 162. Accordingly, the predetermined voltage magnitude threshold of the return signal 212 from the load beam actuator 164 is less than the predetermined voltage magnitude threshold of the return signal 206 from the head actuator 162.

In certain embodiments, the sensor module 204 includes a comparison module 214 that is configured to compare the return signal 206 from the head actuator 162 with the return signal 212 from the load beam actuator 164. Based on the comparison performed by the comparison module 214, the sensor module 204 determines whether the read-write head 110 is touching down on the magnetic disk 115 of the HDD 100. In one implementation, the comparison performed by the comparison module 214 includes calculating a difference between a voltage of the return signal 206 from the head actuator 162 and a voltage of the return signal 212 from the load beam actuator 164. In such an implementation, based on whether the calculated difference meets a predetermined threshold, the sensor module 204 will determine if the read-write head 110 is touching down on the magnetic disk 115 of the HDD 100. Although the comparison module 214 has been described as being configured to compare the return signal 206 from the head actuator 162 with the return signal 212 from the load beam actuator 164, in other embodiments, the comparison module 214 compares the return signal 206 from the head actuator 162, or other actuator, with an actuator other than a load beam actuator 164.

In some implementations, each element of the system 200 is enclosed entirely within the enclosure 102. However, in other implementations, one or more elements of the system 200 is located externally of the enclosure 102.

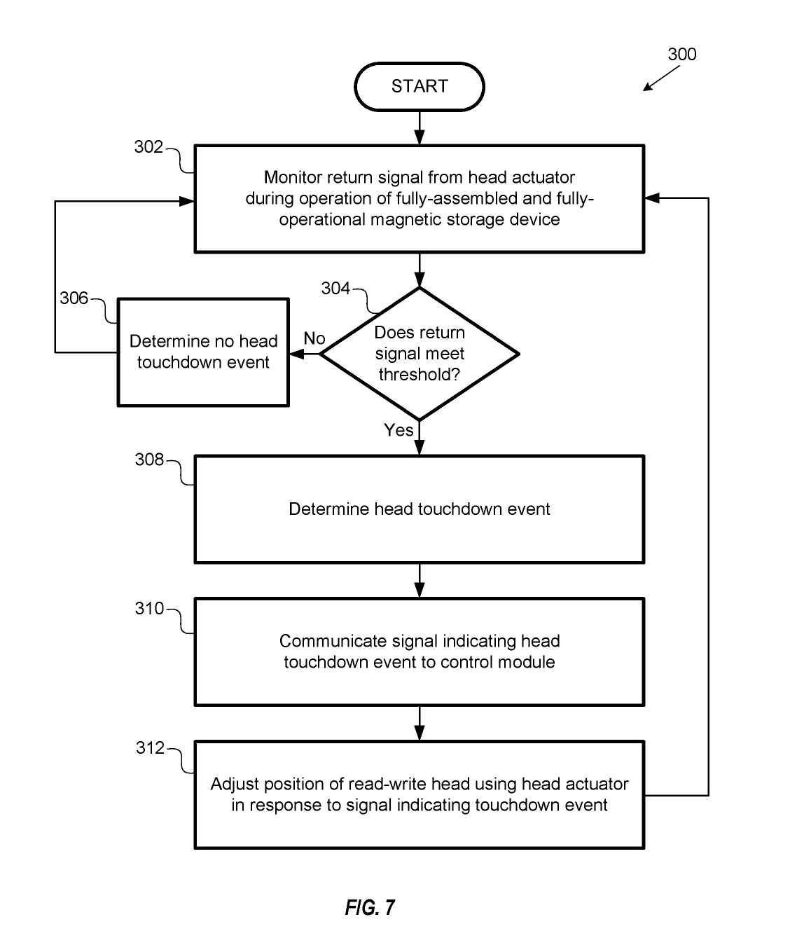

Referring to FIG. 7, according to one embodiment, a method 300 of detecting a touchdown of a read-write head on a magnetic disk of a magnetic storage device during operation of the magnetic storage device is disclosed. The magnetic storage device includes an arm that is rotatable relative to the magnetic disk. The method 300 includes monitoring a return signal from a head actuator during operation of the magnetic storage device (e.g., HDD) at 302. The return signal can be generated by a piezo-electric element of the head actuator, which can be configured to move the read-write head relative to the arm.

Additionally, the method 300 includes determining whether the return signal meets a threshold at 304. In one implementation, determining whether the return signal meets the threshold can include comparing a characteristic, such as a voltage characteristic, of the return signal to a corresponding threshold. If the return signal does not meet the threshold, as determined at 304, then the method 300 determines that a touchdown event is not occurring at 306 and continues to monitor the signal at 302. However, if the return signal meets the threshold, as determined at 304, then the method 300 determines that a head touchdown event is occurring at 308.

According to some implementations, the method 300 additionally includes communicating a signal indicating a touchdown event to a control module at 310 and adjusting a position (e.g., flying height) of the read-write head in response to the signal indicating a touchdown event at 312. The position of the read-write head can be adjusted by the head actuator or another component. According to one implementation, the method 300 may additionally include sealing the read-write head, magnetic disk, arm, and head actuator within an enclosure prior to monitoring the return signal from the head actuator of the magnetic storage device.

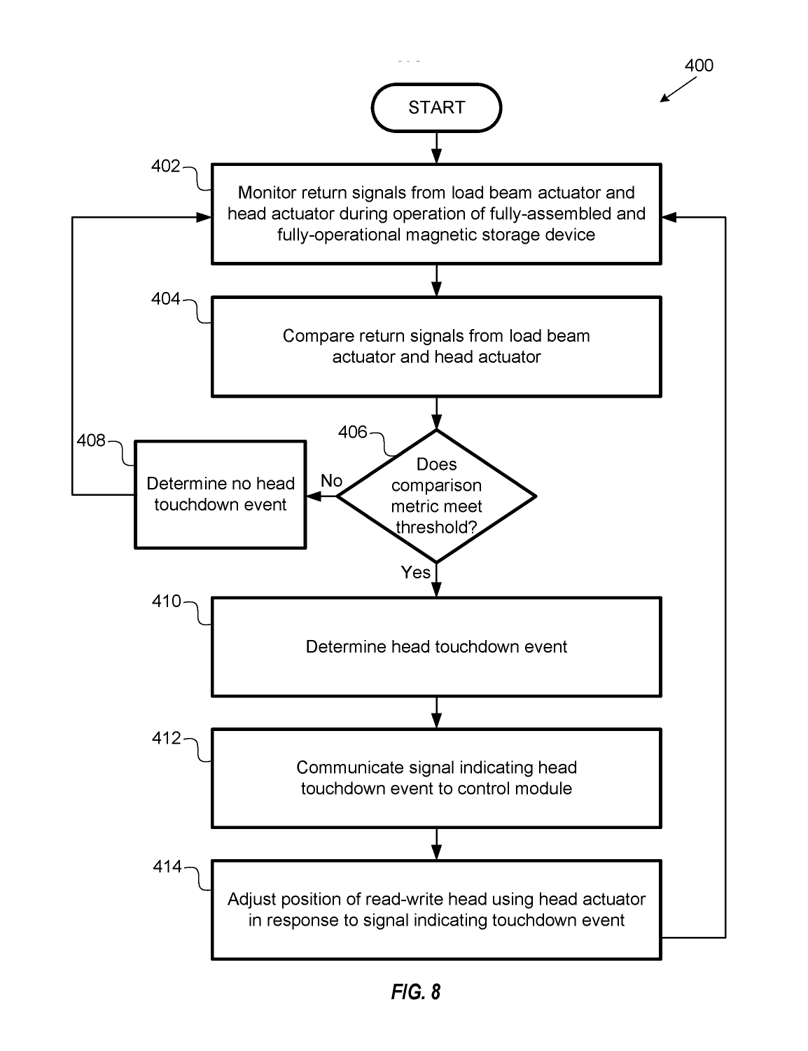

Referring to FIG. 8, according to another embodiment, a method 400 of detecting a touchdown of a read-write head on a magnetic disk of a magnetic storage device during operation of the magnetic storage device is disclosed. The magnetic storage device includes an arm that is rotatable relative to the magnetic disk. The method 400 includes monitoring return signals from a load beam actuator and a head actuator during operation of the magnetic storage device (e.g., HDD) at 402. The return signals can be generated by piezo-electric elements of the respective load beam and head actuators.

Additionally, the method 400 includes comparing the return signals from the load beam actuator and the head actuator at 404. The method 400 further includes determining whether a comparison metric (e.g., voltage difference) of the comparison between the return signals meets a corresponding threshold at 406. If the comparison metric does not meet the threshold, as determined at 406, then the method 400 determines that a touchdown event is not occurring at 408 and continues to monitor the signal at 402. However, if the comparison metric meets the threshold, as determined at 406, then the method 400 determines that a head touchdown event is occurring at 410. According to some implementations, the method 400 additionally includes communicating a signal indicating a touchdown event to a control module at 412 and adjusting a position (e.g., flying height) of the read-write head in response to the signal indicating a touchdown event at 414.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Some of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. A magnetic storage device, fully operational to store digital data, the magnetic storage device comprising:
a magnetic disk;
an arm rotatably movable relative to the magnetic disk;
a head actuator co-movable with the arm, the head actuator comprising at least one piezo-electric element and at least one electronic communication signal line;
a read-write head coupled to the head actuator, wherein the head actuator is operable to move the read-write head relative to the arm responsive to a first electronic signal received from the at least one electronic communication signal line; and
a sensor module configured to determine whether the read-write head has touched down against the magnetic disk based on, at least partially, a second electronic signal received from the head actuator via the at least one electronic communication signal line.

2. The magnetic storage device of claim 1, wherein the head actuator is operable to adjust a flying height of the read-write head relative to the magnetic disk.

3. The magnetic storage device of claim 1, wherein the head actuator is operable to move the read-write head relative to the arm in at least four directions parallel to the magnetic disk.

4. The magnetic storage device of claim 1, wherein the read-write head is coupled directly to the head actuator.

5. The magnetic storage device of claim 1, wherein the sensor module determines that the read-write head has touched down against the magnetic disk when a voltage characteristic of the second electronic signal meets a voltage characteristic threshold.

6. The magnetic storage device of claim 5, wherein the voltage characteristic comprises a period of sustained magnitude.

7. The magnetic storage device of claim 1, further comprising a housing entirely enclosing the magnetic disk, the arm, the head actuator, and the read-write head.

8. The magnetic storage device of claim 1, further comprising a load beam coupled to a first distal end of the arm, wherein the head actuator and the read-write head are positioned at a second distal end of the load beam.

9. The magnetic storage device of claim 1, wherein in a direction perpendicular to a read-write surface of the magnetic disk, the read-write head is interposed directly between the head actuator and the read-write surface of the magnetic disk.

10. A magnetic storage device, comprising:
a magnetic disk;
an arm rotatably movable relative to the magnetic disk;
a load beam coupled to a first distal end of the arm and rotatably movable relative to the arm;
a load beam actuator, comprising at least one first piezo-electric element and operable to rotate the load beam relative to the arm;
a head actuator co-movable with the load beam, the head actuator comprising at least one second piezo-electric element;
a read-write head coupled to the head actuator, wherein the head actuator is operable to move the read-write head relative to the load beam; and
a sensor module configured to determine whether the read-write head has touched down against the magnetic disk based on, at least partially, a first electronic signal received from the head actuator.

11. The magnetic storage device of claim 10, wherein the sensor module is configured to determine whether the read-write head has touched down against the magnetic disk based further on, at least partially, a second electronic signal received from the load beam actuator.

12. The magnetic storage device of claim 11, wherein the sensor module is configured to determine whether the read-write head has touched down against the magnetic disk based on, at least partially, a comparison between the first electronic signal and the second electronic signal.

13. The magnetic storage device of claim 12, wherein the comparison comprises a difference between a voltage of the first electronic signal and a voltage of the second electronic signal.

14. The magnetic storage device of claim 10, wherein the head actuator and the read-write head are coupled to the load beam at a second distal end of the load beam.

15. A method of detecting a touchdown of a read-write head on a magnetic disk of a magnetic storage device during operation of the magnetic storage device, wherein the magnetic storage device comprises an arm rotatable relative to the magnetic disk, the method comprising:
monitoring a return signal from a head actuator of the magnetic storage device, the head actuator comprising at least one piezo-electric element and operable to move the read-write head relative to the arm;
comparing a voltage characteristic of the return signal from the head actuator to a first threshold;
detecting the touchdown of the read-write head on the magnetic disk when the voltage characteristic of the return signal from the head actuator meets the first threshold; and
adjusting a position of the read-write head relative to the magnetic disk in response to detecting the touchdown of the read-write head on the magnetic disk.

16. The method of claim 15, wherein:
the magnetic storage device further comprises a load beam coupled to a first distal end of the arm;
the head actuator is operable to move the read-write head relative to the load beam; and
the head actuator and the read-write head are positioned at a second distal end of the load beam.

17. The method of claim 16, further comprising:
monitoring a return signal from a load beam actuator of the magnetic storage device, the load beam actuator comprising at least one piezo-electric element and operable to move the load beam relative to the arm;
comparing a voltage characteristic of the return signal from the load beam actuator to a second threshold; and
detecting the touchdown of the read-write head on the magnetic disk when the voltage characteristic of the return signal from the head actuator meets the first threshold and the voltage characteristic of the return signal from the load beam actuator meets the second threshold.

18. The method of claim 15, wherein the head actuator adjusts the position of the read-write head relative to the magnetic disk in response to detecting the touchdown of the read-write head on the magnetic disk.

19. The method of claim 18, wherein the head actuator adjusts a flying height of the read-write head relative to the magnetic disk in response to detecting the touchdown of the read-write head on the magnetic disk.

20. The method of claim 15, further comprising sealing the read-write head, magnetic disk, arm, and head actuator within an enclosure prior to monitoring the return signal from the head actuator of the magnetic storage device.
